(19) United States
(12) Patent Application Publication
(10) Pub. No.: US 2005/0146500 A1
(43) Pub. Date: Jul. 7, 2005

(54) Pointing Device For Multiple-Dimensional Scrolling Control

(76) Inventor: Yu-Chih Cheng, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,417

(22) Filed: Jul. 9, 2004

(30) Foreign Application Priority Data
Dec. 25, 2003 (TW) 092136834

(51) Int. Cl. G09G 5/08

(52) U.S. Cl. 345/163

(57) ABSTRACT

A pointing device includes a wheel module capable of swinging left and right with respect to a housing. With rotation of the wheel and swinging of the wheel module, multiple-dimensional scrolling control is provided. In the wheel module, an optical rotation-sensing module is set beside the wheel to sense its rotation, and an elastic step unit, installed on the wheel module, engages a step-wise uneven ring inside the wheel for generating a stepwise vibration feeling when the wheel is rotated.

### BACKGROUND OF INVENTION

1. Field of the Invention

The invention relates to a pointing device, and more particularly, to a pointing device for multiple-dimensional scrolling control with simple manufacture and assembly.

2. Description of the Prior Art

Computer systems have become one of the most important hardware backbones in modern information society. Most modern computer systems are equipped with a pointing device (such as a mouse) so that the computer operator can work with a computer more conveniently. Through the graphic user interface (GUI) on the display screen, the operator can intuitively do what they want with the computer using the pointing device. Meanwhile, manufacturers are continuously making improvements in the designs of pointing device for functional enhancement, more convenient operation, and satisfaction of user needs.

Please refer to FIG. 1, which is an illustration of a prior art pointing device 10. The pointing device 10 is a mouse having two buttons 12A, 12B, and a wheel 14 that can rotate about a rotary shaft Ap along an arrow 16. While the operator moves the mouse 10, it detects movement either mechanically with a solid ball or optically. The movement detected is converted into corresponding movement-sensing signals and transmitted to a computer system, not shown in FIG. 1, in the form of electrical signals to be processed on the computer. Also, the mouse 10 detects the pressing of the buttons 12A, 12B and transmits the corresponding button-sensing signals to a computer system to provide additional manipulations. Furthermore, as a computer operator often needs to view many different parts of a document, text, spreadsheets, web pages, or graphics on the display screen having limited display region, the wheel 14 on the mouse provides the function of scrolling up and down the contents on the screen. The mouse 10 detects the amount of the rotation as the operator rotates the wheel 14 and generates the corresponding rotation-sensing signals that can be transmitted to a computer system to display the upper part or the lower part of a document; equivalently, the document is scrolled vertically.

Even though the wheel 14 of a prior art mouse 10 provides the ability of scrolling vertically, it scrolls only along one direction, which is unsatisfactory when the width of some wide screen pages, graphics, or engineering plots exceed the screen width. In such cases, an operator needs to view the leftmost/rightmost part of the document in an easy way. That is to say, an additional function that allows scrolling horizontally in a document would be welcomed by computer operators. The prior art mouse 10 provides only the ability for one-dimensional scrolling, such as vertical scrolling, and does not allow computer operators the convenience of scrolling horizontally with the same wheel at the same time. Although an on-going application for the patent in the United States (U.S. patent application No. 20030025673A1) also proposes the technique including a wheel assembly for scrolling an image in multiple directions, it bears the drawbacks of not only complicated structure, high cost and time needed for production, assembly, and manufacturing, but also discomfort to the user in the way the wheel rotates.

### SUMMARY OF INVENTION

It is therefore a primary objective of the claimed invention to provide a pointing device for multiple-dimensional scrolling control with one single scrolling wheel. The present invention is simple in structure, easy to produce and assemble, and simple to manufacture. In addition, the present invention helps computer operators gain more control of the positioning of the device and the amount of rotation of the wheel by providing a step-wise vibration feeling while rotating the wheel.

One aspect of the present invention relates to a wheel module including a pedestal and a wheel connected to the pedestal. The wheel module is connected to the housing and capable of swinging left and right. The rotation of the wheel itself provides the control of vertical scrolling and the swing of the wheel module provides the control of horizontal scrolling. Thus, operators are capable of carrying out multiple-dimensional scrolling control with one single wheel module.

Another aspect of the present invention relates to the detailed structure of the wheel module. An optical gate is disposed on one side of the wheel and a light emitting element and a light receiving element are disposed on both sides of the pedestal to detect the amount of rotation of the wheel. On the other side of the wheel, the step surface is distributed evenly on the inner circumference of the wheel; correspondingly, a step unit is disposed on the pedestal having one end connected to the pedestal and the other end contacting the step surface and moving back and forth elastically. When the operator rotates the wheel, the convex and the concave segments of the step surface alternatively stretch and compress the step unit and cause a step-wise vibration feeling so that the operator can control and position the wheel easily.

The pedestal of the wheel module having a swing shaft is connected to the base plate of the housing. The front end of the swing shaft is fixed to the base plate and the other end of the swing shaft is connected to the housing vertically free on the base plate pivoting about the front end of the swing shaft so that the operator is capable of clicking the wheel and causing vertical movement of the wheel module.

With the various novel designs disclosed by the present invention, the pointing device provides the control for multiple-dimensional scrolling. Moreover, the simplicity of the structure further lowers the cost and time needed to produce, assemble, and manufacture the pointing device. Easy manipulation and positioning of the wheel is also attained.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a prior art pointing device.

FIG. 2 illustrates the present invention pointing device.

FIG. 3 is an exploded view of the pointing device of FIG. 2.

FIG. 4 and FIG. 5 are different perspectives of the wheel module of FIG. 3.

FIG. 6 and FIG. 7 are different perspectives of the wheel of FIG. 3.

FIG. 8 and FIG. 9 are sectional diagrams of the wheel module of FIG. 3.

FIG. 10 illustrates two different rotation situations of the wheel module of FIG. 3.

FIG. 11 is a diagram of the wheel module removed from the housing of FIG. 3.

FIG. 12 is a diagram of the wheel module connected to the housing of FIG. 3.

FIG. 13 is a top view of the assembly of FIG. 12.

FIG. 14 is a rear view of the assembly of FIG. 12.

FIG. 15 is a side view of the assembly of FIG. 12.

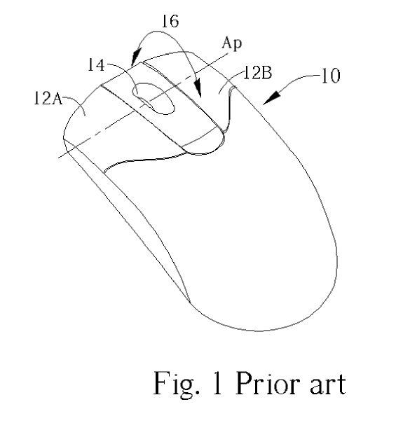

### DETAILED DESCRIPTION

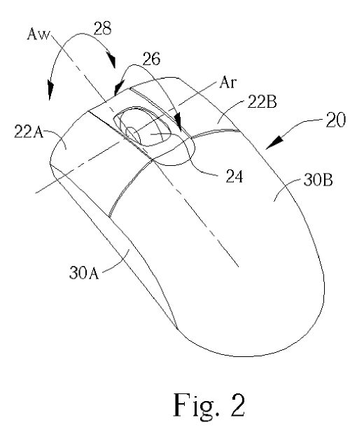

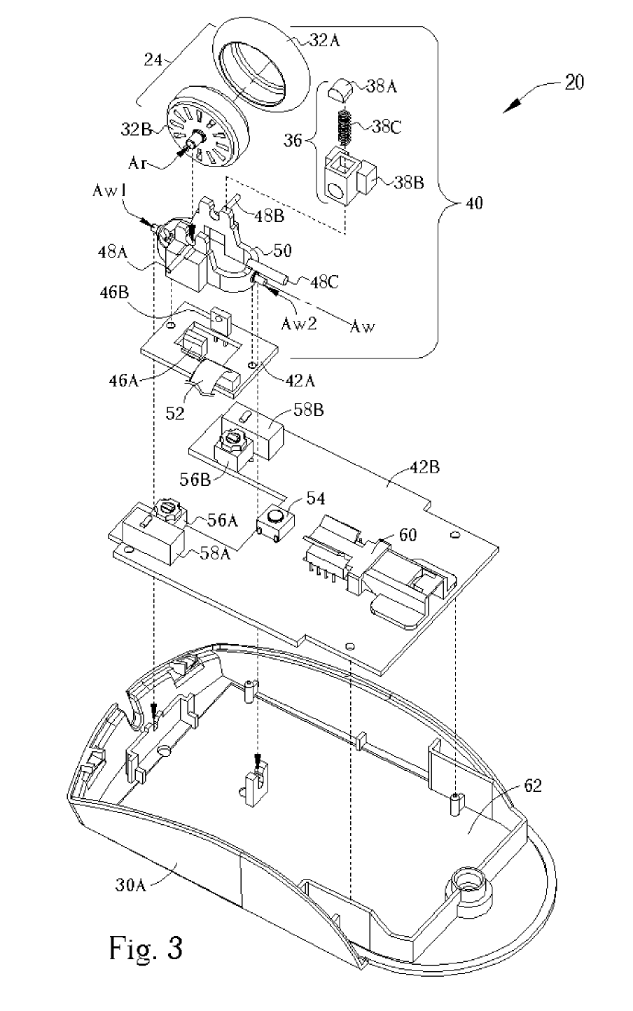

Please refer to FIG. 2 and FIG. 3. FIG. 2 shows an exemplary embodiment of a present invention pointing device 20. FIG. 3 illustrates the components of the pointing device 20. The pointing device 20 is a mouse including a housing 30A, 30B with buttons 22A, 22B and having a wheel 24 for scrolling control. In the present invention, the wheel 24 is disposed in a wheel module 40, as in FIG. 3, where the wheel 24 is capable of rotating about a rotary shaft Ar in the direction of an arrow 26 and swinging left right about a swing shaft Aw in the direction of an arrow 28. Therefore, vertical scrolling control is achieved by the rotation of the wheel 24 in the direction of the arrow 26 and horizontal scrolling control is achieved by the swing of the wheel 24 in the direction of the arrow 28.

As FIG. 3 shows, besides the wheel 24, the present invention wheel module 40 includes a pedestal 50, a circuit board 42A, a light emitting element 46B, a light receiving element 46A, and a step unit 36 (the housing 30B is removed in FIG. 3). The wheel 24 includes wheel components 32A, 32B and is installed on the pedestal 50 and rotates about the rotary shaft Ar. The pedestal 50 has three extending touch rods 48A-48C and the swing shaft Aw on the bottom, extending from a front swing shaft end Aw1 to a rear swing shaft end Aw2. The circuit board 42A is connected to the bottom of the pedestal 50 as a whole. The light emitting element 46B and the light receiving element 46A are installed on the circuit board 42A and located on either side of the wheel 24 respectively to form a rotation-sensing module that detects the amount of rotation of the wheel 24. The light emitting element 46B emits light and the light receiving element 46A detects light and generates a corresponding rotation-sensing signal that is transmitted as an electrical signal through a bus 52 on the circuit board 42A. In addition, the step unit 36 includes step unit components 38A, 38B and an elastic body 38C (such as a spring). The elastic body 38C is placed between the step unit components 38A, 38B, where the step unit component 38B is the step body of the step unit 36 and is fixed to the pedestal 50 and the step unit component 38A is the push pad elastically moving back and forth relative to the step body by the elasticity of the elastic body 38C.

The wheel module 40 is moveably connected to a base plate 62 in the housing 30A. A circuit board 42B that is connected to the base plate 62 has button sensors 58A, 58B, swing sensors 56A, 56B, a click sensor 54, and a movement-sensing module 60. The movement-sensing module 60 can be an optical sensing module or a mechanical sensing module with a rolling ball. When the operator moves the pointing device 20, the movement-sensing module 60 detects movement of the pointing device 20 and generates a corresponding movement-sensing signal. The button sensors 58A, 58B detect the pressing of the buttons 22A, 22B (shown in FIG. 2), respectively, and generate a corresponding button-sensing signal. The swing sensors 56A, 56B form a swing-sensing module and detect the swing of the wheel module 40 and generate the corresponding swing-sensing signal. The click sensor 54 detects up-and-down movement of the wheel module 40 and generates a corresponding click-sensing signal. All the above electrical sensing signals generated by the sensors/sensing modules are transmitted through the circuits on the circuit board 42B to a computer system (not shown); likewise, the bus 52 of the wheel module 40 connects to the circuit board 42B that transmits the rotation-sensing signal generated by the rotation-sensing module to a computer system.

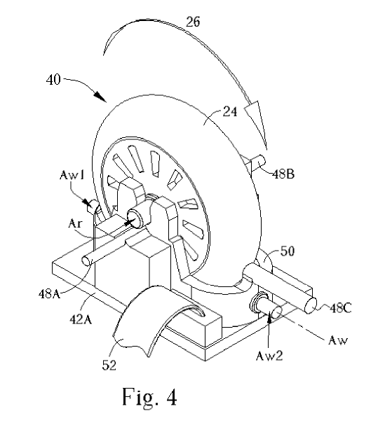

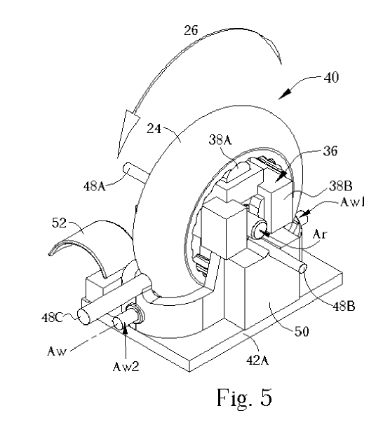

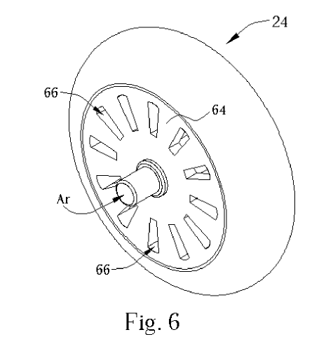

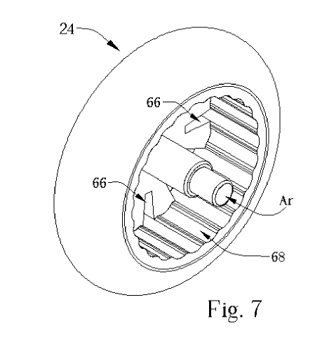

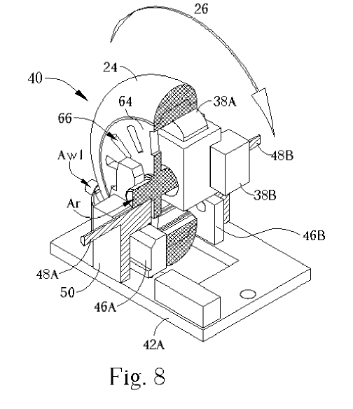

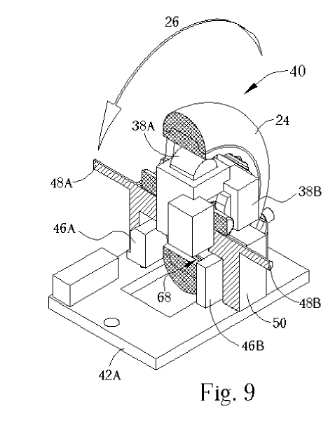

Please refer to FIG. 4 to FIG. 9 (also FIG. 2 and FIG. 3) for detailed information of the components of the present invention pointing device 20. With different angles of view, FIG. 4 and FIG. 5 are illustrations of the assembly of the wheel module 40. As mentioned before, the wheel 24 rotates about the rotary shaft Ar in the direction of the arrow r 26. FIG. 6 and FIG. 7 show the detailed structure of the wheel 24 from different angles of view. FIG. 8 and FIG. 9 show the step unit 36 and the interrelationship between the rotation-sensing module and the wheel 24.

As FIG. 6 and FIG. 7 show, a plurality of radial slits 66 is placed on a plane of the wheel 24. These slits 66 form light-passing areas of the plane. The areas between the slits 66 are light-blocking areas. The light-passing areas and the light-blocking areas are placed alternatively along the rotary shaft Ar and form an optical gate 64. FIG. 7 shows a step surface 68 distributed evenly on the inner circumference of the wheel 24. FIG. 8 and FIG. 9 show that the optical gate 64 is installed between the light emitting element 46B and the light receiving element 46A. As the operator rotates the wheel 24, the optical gate 64 rotates so light-passing areas and light-blocking areas alternately pass between the light-emitting element 46B and the light-receiving element 46A. When a slit 66 passes by, the light from the light-emitting element 46B passes through the slit and is received by the light-receiving element 46A. Conversely, when a light-blocking area passes by, the light from the light-emitting element 46B is blocked and not received by the light-receiving element 46A. In other words, the amount of rotation of the wheel 24 is obtained according to alternating light-passing and light-blocking, and is converted into the rotation-sensing signal to carry out vertical scrolling control.

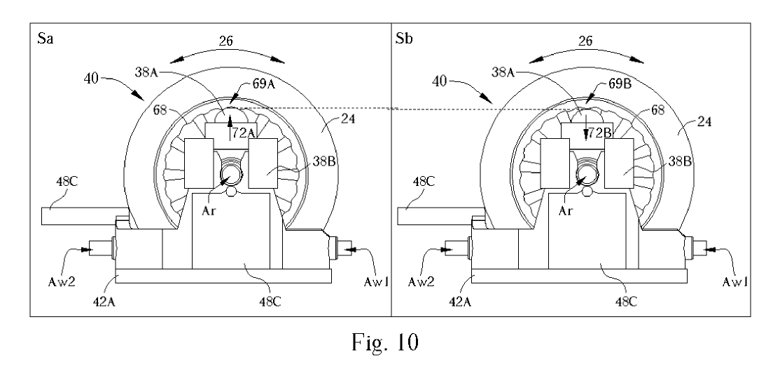

The step unit 36 in FIG. 9 shows that the step unit component 38A (such as a push pad) contacts the step surface as a result of the elasticity of the elastic body 38C as in FIG. 3. When the wheel 24 rotates, the step surface 68 also moves through the step unit component 38A, propelling the step unit component 38A to move up and down to generate the step-wise vibration feeling. Please refer to FIG. 10 for detailed information. FIG. 10 shows the up-and-down movement of the step unit component 38A in a side view as the wheel 24 rotates. In state Sa, a concave segment 69A of the step surface 68 passes through the step unit component 38A that then is lifted along the direction of an arrow 72A by the elasticity of the elastic body 38C in the step unit 36. When the wheel 24 turns into a state Sb along the direction of the arrow 26, a convex segment 69B of the step surface 68 passes through the step unit component 38A that then is pressed downward along the direction of an arrow 72B. As the wheel 24 rotates, the step unit component 38A is in the states of Sa and Sb alternatively, i.e., it vibrates vertically along the arrows 72A, 72B to generate a step-wise vibration feeling.

As FIG. 4 to FIG. 10 show, the present invention wheel module 40 generates a control signal from the rotation of the wheel 24. Also, when an operator rotates the wheel 24, the step unit 36 generates a step-wise vibration feeling that improves the handling of the wheel 24. The frequency of the vibration feeling assists the operator in knowing the rotating rate of the wheel 24 so that the operator can control the wheel more intuitively to get to an appropriate scrolling rate of a document on the display screen. In addition, the step unit 36 allows the wheel 24 to be readily fixed in one place if the operator vertically scrolls a document and needs to stay in some specific part of the document.

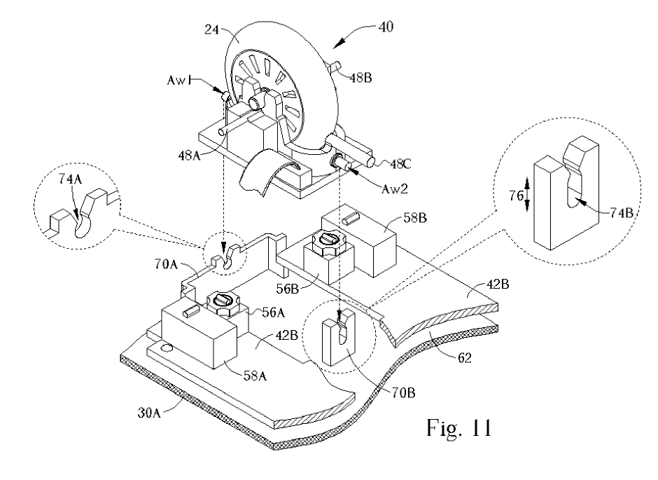

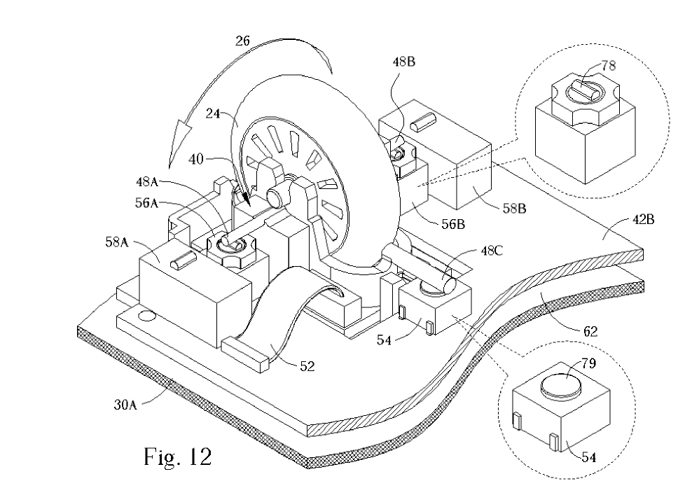

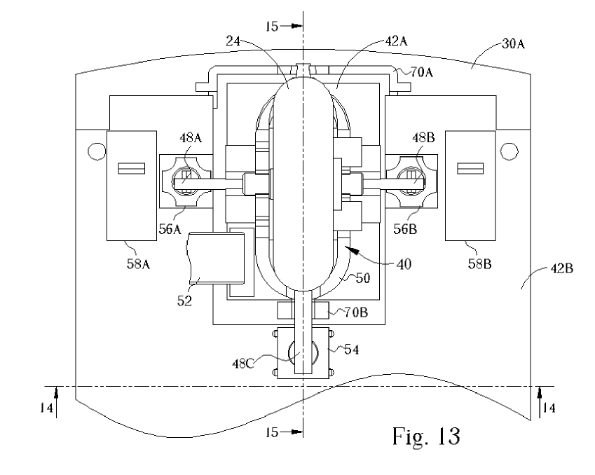

Please refer to FIG. 11 to FIG. 12 showing the present invention wheel module 40 connected moveably to the housing 30A. FIG. 11 illustrates how the wheel module 40 is connected to the housing 30A. And FIG. 12 illustrates the assembly of the wheel module 40 and the housing 30A. FIG. 13 is a top view of FIG. 12. Parts of the housing 30A and the circuit board 42B are not depicted in FIG. 11 to FIG. 13 for clarity. As FIG. 11 shows, two convex plates 70A, 70B are built on the base plate 62 of the housing 30A. The convex plate 70A includes an aperture 74A and the convex plate 70B includes a slot 74B. The aperture 74A matches the swing shaft end Awl of the wheel module 40 holding the swing shaft Awl but allowing rotation. The other swing shaft end Aw2 of the wheel module 40 is placed in the slot 74B capable of rotating and also vertically sliding through in the direction of an arrow 76. In other words, as the wheel module 40 is connected to the housing 30A by the swing shaft ends Aw1, Aw2, the wheel module 40 is capable of not only swinging left right about the swing shaft Aw extended from the swing shaft end Aw1 to the swing shaft end Aw2 (i.e., about the direction of the arrow 26 in FIG. 12) but also sliding vertically along the direction of the arrow 76 with the swing shaft end Aw2 pivoting about the swing shaft end Aw1.

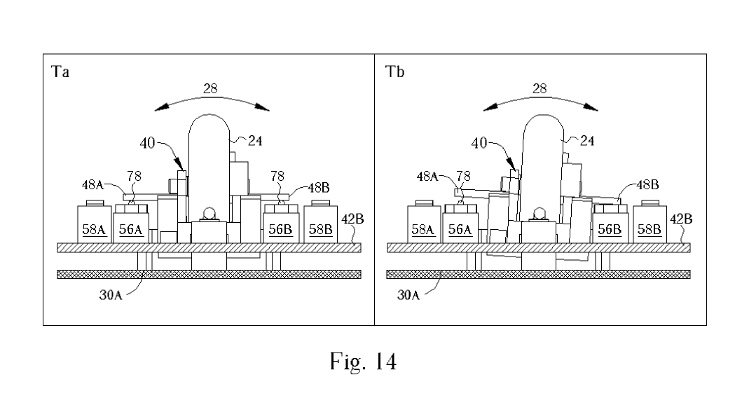

As FIG. 12 and FIG. 13 show, the touch rods 48A, 48B, and 48C of the wheel module 40 correspond respectively to the swing sensors 56A, 56B and the click sensor 54 when the wheel module 40 is connected to the housing 30A. In a preferred embodiment of the present invention, the swing sensors and the click sensor are made with elastic touch button sensors. As FIG. 12 shows, when a touch button 79 of the click sensor 54 is pressed, the click sensor 54 generates a click-sensing signal in response and returns elastically (with a spring inside, for example) the touch button 79 to its status before clicking. Likewise, a touch button 78 having elastic restoration ability is set on the swing sensors 56A, 56B. With these sensors having elastic restoration ability, the present invention elastically supports the mobile wheel module 40 using a simplified structure. Please refer to FIG. 14, a rear view diagram along the section line 14-14 in FIG. 13, for illustrative description of swinging left and right.

In a state Ta in FIG. 14, the touch rods 48A, 48B on both sides of the wheel module 40 are held respectively by the touch buttons 78 of the swing sensors 56A and 56B and keep the wheel module 40 right in the middle. When an operator swings the wheel module 40 along the direction of the arrow 28, the touch rod 48A or 48B presses the touch button 78 of the swing sensor 56A or 56B. The state Tb in FIG. 14 illustrates the touch button 78 of the swing sensor 56B being pressed down by the touch rod 48B as the operator tilts the wheel module 40 to the right; meanwhile, the swing sensor 56b generates a corresponding swing-sensing signal to indicate that the wheel module 40 has been tilted. Once the tilting of the wheel module 40 stops, the touch button 78 of the swing sensor 56B elastically returns to the position in the state Ta, bringing back the whole wheel module 40 to the middle.

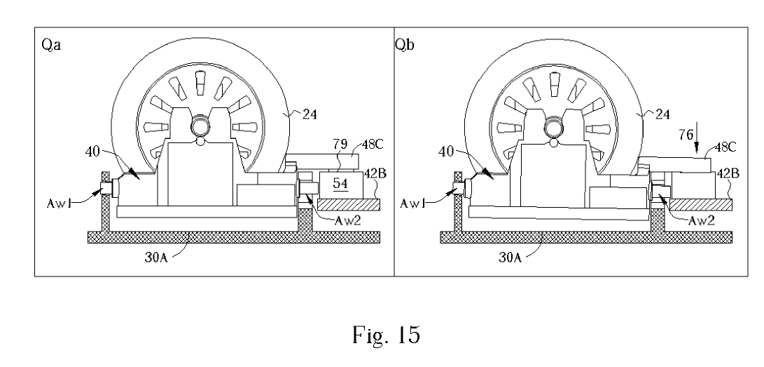

Continuing to FIG. 15, a side view diagram along the section line 15-15 in FIG. 13, it shows a vertical movement of the wheel module 40 pivoting about the swing shaft end Aw1. A state Qa in FIG. 15 shows that the touch rod 48C of the wheel module 40 is kept horizontal by the support of the touch button 79 of the click sensor 54. And a state Qb shows that if the operator presses down the wheel 24, the swing shaft end Aw2 of the whole wheel module 40 moves downward the direction of the arrow 76 pivoting about the swing shaft end Aw1, and the touch rod 48C then presses the touch button 79 of the click sensor 54 to generate the click-sensing signal. The click-sensing signal indicates that the wheel 24 (or the wheel module 40) has been pressed. After the wheel 24 is released, the touch button 79 of the click sensor 54 returns elastically to the position of the state Qa, and the wheel module 40 goes back to the horizontal status as in Qa.

The wheel module 40 of the present invention disclosed in the above discussion is capable of swinging left and right (FIG. 14) and moving vertically (FIG. 15). The swing motion is detected by the swing sensors 56A, 56B and provides the vertical scrolling control. The vertical movement is detected by the click sensor 54 and provides the clicking control. With the additional vertical scrolling control by the rotation of the wheel 24 itself (FIG. 4 to FIG. 10), the present invention pointing device 20 allows intuitive muliple-dimensional scrolling control with one single wheel.

In contrast to the prior art, the present invention pointing device is capable of realizing a multiple-dimensional scrolling control with one single, simply structured wheel/wheel module and preserving the step-wise vibration feeling while the wheel is rotating. With the front shaft end and the rear shaft end of the present invention wheel module connecting directly to the base plate of the housing and the touch buttons of the click sensor and the swing sensors elastically supporting the mobile wheel module, the present invention pointing device is implemented with simple structure, lower cost and time for production, and easy assembly for manufacturing. In addition to the scrolling control, the present invention swingable wheel module also allows other types of multiple-dimensional control, for example, all-directional control in a virtual-reality environment in computer games, etc. In addition, the embodiment of the present invention applies to not only on a mouse-like pointing device but also other types of pointing devices such as a track balls, etc.

Those skilled in the art will readily observe that numerous modifications and alterations of the device may be made while retaining the teachings of the invention. Accordingly, the above disclosure should be construed as limited only by the metes and bounds of the appended claims.

1. A pointing device comprising:
a housing having base plate;
a wheel module comprising:
a pedestal having a swing shaft extended there through, the pedestal capable of swinging left and right about the swing shaft, the swing shaft pivotally connected to the base plate of the housing;
a wheel installed on the pedestal and rotatable about a rotary shaft that extends from the left of the pedestal to the right and is perpendicular to the swing shaft, the wheel including a step surface having at least one concave segment and at least one convex segment on an inner circumference of the wheel; and
a step unit having a step body fixed on the pedestal and a push pad elastically connected to the step body, the push pad contacting the step surface and moving back and forth relative to the step body as a result of the push pad contacting the concave and convex segments when the wheel is rotated; and
a swing-sensing module installed on the housing for detecting the swing of the pedestal about the swing shaft and for generating a corresponding swing-sensing signal.

2. The pointing device of claim 1, wherein a front end of the swing shaft is vertically fixed to the base plate of the housing and a rear end of the swing shaft is vertically free to move up and down pivoting about the front end of the swing shaft, the pointing device further comprising:
a click sensor installed in the housing for detecting vertical movement of the pedestal and generating a corresponding click-sensing signal.

3. The pointing device of claim 1 further comprising:
a rotation-sensing module installed on the pedestal for detecting the rotation of the wheel about the rotary shaft and generating a corresponding rotation-sensing signal.

4. The pointing device of claim 3 wherein an optical gate is disposed on the wheel, the optical gate having at least one light-passing area and one light-blocking area, the rotation-sensing module further comprising:
a light emitting element installed on one side of the pedestal for emitting a light beam; and
a light receiving element installed on the other side of the pedestal, wherein when the optical gate rotates with the wheel, the light-passing areas and the light-blocking areas alternately pass between the light emitting element and the light receiving element.

5. The pointing device of claim 1 wherein the housing further comprises:
at least one button; and
at least one button sensor for detecting the press of the button and generating a corresponding button-sensing signal.

6. A pointing device comprising:
a housing having base plate;
a wheel module comprising:
a pedestal having a swing shaft extended there through, the pedestal capable of swinging left and right about the swing shaft, the swing shaft pivotally connected to the base plate of the housing;
a wheel installed on the pedestal and rotatable about the rotary shaft that extends from the left of the pedestal to the right and is perpendicular to the swing shaft, the wheel including an optical gate having at least one light-passing area and one light-blocking area;
a rotation-sensing module for detecting the rotation of the wheel about the rotary shaft and generating a corresponding rotation-sensing signal, the rotation-sensing module comprising:
a light emitting element installed on one side of the pedestal for emitting a light beam; and
a light receiving element installed on the other side of the pedestal, wherein when the optical gate rotates with the wheel, the light-passing areas and the light-blocking areas alternately pass between the light emitting element and the light receiving element; and
a swing-sensing module installed on the housing for detecting the swing of the pedestal about the swing shaft and for generating a corresponding swing-sensing signal.

7. The pointing device of claim 6 wherein the wheel includes a step surface having at least one concave segment and at least one convex segment on an inner circumference of the wheel, the pointing device further comprising:
a step unit having a step body fixed on the pedestal and a push pad elastically connected to the step body, the push pad contacting the step surface and moving back and forth relative to the step body as a result of the push pad contacting the concave and convex segments when the wheel is rotated.

8. The pointing device of claim 6, wherein a front end of the swing shaft is vertically fixed to the base plate of the housing and a rear end of the swing shaft is vertically free to move up and down pivoting about the front end of the swing shaft, the pointing device further comprising:
a click sensor installed in the housing for detecting vertical movement of the pedestal and generating a corresponding click-sensing signal.

9. The pointing device of claim 6 wherein the housing further comprises:
at least one button; and
at least one button sensor for detecting the press of the button and generating a corresponding button-sensing signal.

10. A pointing device comprising:
a housing having base plate;
a wheel module comprising:
a pedestal having a swing shaft extended there through, the pedestal capable of swinging left and right about the swing shaft, the swing shaft pivotally connected to the base plate of the housing, wherein a front end of the swing shaft is vertically fixed to the base plate of the housing and a rear end of the swing shaft is vertically free to move up and down pivoting about the front end of the swing shaft;
a wheel installed on the pedestal and rotatable about the rotary shaft that extends from the left of the pedestal to the right and is perpendicular to the swing shaft; and
a click sensor installed in the housing for detecting vertical movement of the pedestal and generating a corresponding click-sensing signal; and
a swing-sensing module installed on the housing for detecting the swing of the pedestal about the swing shaft and for generating a corresponding swing-sensing signal.

11. The pointing device of claim 10 wherein the wheel includes a step surface with at least one concave segment and at least one convex segment on an inner circumference of the wheel, the pointing device further comprising:
a step unit having a step body fixed on the pedestal and a push pad elastically connected to the step body, the push pad contacting the step surface and moving back and forth relative to the step body as a result of the push pad contacting the concave and convex segments when the wheel is rotated.

12. The pointing device of claim 10 further comprising:
a rotation-sensing module installed on the pedestal for detecting the rotation of the wheel about the rotary shaft and generating a corresponding rotation-sensing signal.

13. The pointing device of claim 12 wherein an optical gate is disposed on the wheel, the optical gate having at least one light-passing area and one light-blocking area, the rotation-sensing module further comprising:
a light emitting element installed on one side of the pedestal for emitting a light beam; and
a light receiving element installed on the other side of the pedestal, wherein when the optical gate rotates with the wheel, the light-passing areas and the light-blocking areas alternately pass between the light emitting element and the light receiving element.

14. The pointing device of claim 10 wherein the housing further comprises:
at least one button; and
at least one button sensor for detecting the press of the button and generating a corresponding button-sensing signal.
